(19) United States
(12) Patent Application Publication
(10) Pub. No.: US 2006/0128377 A1
(43) Pub. Date: Jun. 15, 2006

(54) Interception of groups of subscribers

(76) Inventors: Leopold Murhammer, WIEN (AT); Bernhard Spalt, Wien (AT)

Correspondence Address: MORRISON & FOERSTER LLP, 1650 TYSONS BOULEVARD, SUITE 300, MCLEAN, VA, 22102, US

(21) Appl. No.: 10/543,086

(22) PCT Filed: Nov. 20, 2003
(86) PCT No.: PCT/EP03/13040

§ 371 Date: Jul. 22, 2005

(30) Foreign Application Priority Data
Jan. 24, 2003 (EP) 03001632.3

(51) Int. Cl. H04Q 7/20

(52) U.S. Cl. 455/428; 455/445

(57) ABSTRACT

An efficient decision of the necessity of an authority to intercept telecommunications connections is made possible by a method for deciding to intercept a telecommunications connection during which it is verified whether an identification detail concerning at least one subscriber of the telecommunications connection is contained in at least one identification detail abbreviation, which concerns the subscriber to be monitored and which is stored in a list. In the event this identification detail is contained in the list, an interception of the telecommunications connection is initiated.

The invention relates to methods and devices for intercepting telecommunications connections.

In mobile radio networks, as is known to the person skilled in the art, it is possible to have official monitoring (interception) of telecommunications connections which are routed to suspect subscribers, by comparing identification information relating to telecommunications subscribers taking part in the connection with stored lists of telecommunications subscribers to be monitored when a connection is established, with interception of the telecommunications connection being initiated if identification information of at least one telecommunications subscriber is contained in a list of identification information relating to telecommunications subscribers to be monitored.

The object of the present invention is to simplify the process of establishing whether subscribers of a telecommunications connection are to be intercepted. The object is achieved by the objects of the independent claims in each case.

By storing identification detail abbreviations which can be parts of the identification details relating to a number of subscribers in lists relating to telecommunication subscribers to be intercepted it is possible to reduce the number of list entries to be checked. It is also possible to identify a very large number of telecommunications subscribers with one identification detail abbreviation, for example all subscribers with the prefix digits +49 89*.

In this case the identification detail abbreviation can especially be part of an identification detail relating to a mobile radio subscriber number, by which a large number of mobile radio subscribers can be identified by one identification detail abbreviation (+49 89*) of a large area by one entry in a list of telecommunications subscribers to be intercepted and simply identified as to be intercepted. Likewise specific groups of international mobile station equipment identities (IMEI) can be identified for monitoring by abbreviations of terminal numbers.

Further It is possible to use the invention to identify for interception a plurality of telecommunications subscribers with specific e-mail addresses. In particular all telecommunications subscribers with a specific domain name (*@aol.de or *@arcor.de etc.) can be entered for interception into a list of identification detail abbreviations.

The invention is especially suitable for use with telecommunications connections routed via mobile radio networks and/or fixed networks and/or the Internet.

The checking can be done by equipment in a mobile radio network or by equipment connected to equipment of a mobile radio network.

The invention is intended for use by official bodies.

Further features and advantages of the invention are produced by the claims and the subsequent description of an exemplary embodiment with reference to the drawing.

The Figure shows

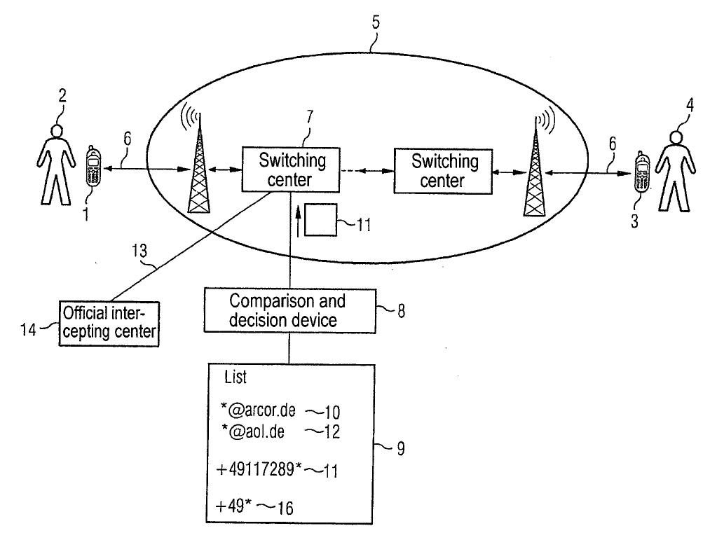

FIG. 1 schematic diagram of the method and devices for interception of telecommunication connections in accordance with the invention.

A mobile radio terminal 1 of a subscriber 2 is to be connected to a mobile radio terminal 3 of a subscriber 4 via a telecommunications connection 6 routed via a telecommunications network 5 (mobile radio network and/or fixed network and/or Internet). In this case an identification detail (relating to the international mobile subscriber (IMSI) and/or the mobile station equipment (IMEI) and/or an e-mail address) originating from a subscriber terminal is compared on setup of the telecommunications connection 6 (or alternatively transferred on transmission of data packets over the telecommunications connection 6) by equipment 7 or by equipment 8 connected to it by comparison and decision equipment 8 with a list 10, 11, 12 of identification detail abbreviations stored in a memory 9 in order to establish whether at least one of the subscribers makes an interception of the telecommunications connection necessary. To this end a check is made as to whether the identification detail relating to a subscriber is contained in an identification detail abbreviation 10, 11, 12 in the stored list 9. For example a telephone number +49 172 89 12345 of a subscriber terminal 1 can be contained in an identification detail abbreviation +49 172 89* (“*” stands for any given sequence) in the list 9, in which case the telecommunications connection 6 (with the terminal 1 of this subscriber 2) is monitored—for example in that a copy of data transmitted over the telecommunications connection 6 is transmitted over a connection 13 to an official intercepting center 14. Instead of a telephone number abbreviation, an identification detail abbreviation can also represent a part of an e-mail address of a subscriber 2, 4, especially for example the domain part of an e-mail address. Thus for example the identification detail abbreviation “@arcor.de” can contain an abbreviation of the identification detail “first name1.last name@arcor.de”, “first name2.last name”@arcor.de”, “first name3.last name3@arcor.de”, i.e. an abbreviation of all e-mail specifications containing “@arcor.de”. If, when a telecommunication connection is set up or on transmission of data over a telecommunications connection, identification details of one of the subscribers are transferred, the identification details relating to this subscriber or the other subscriber of the telecommunications connection can be compared by the comparison and decision equipment 8 with stored identification detail abbreviations in order to establish whether an identification detail 1 of a subscriber makes it necessary to intercept the telecommunications connection 6, and if necessary a transfer of a copy to an official intercepting center 14 can be initiated by equipment 7.

An identification detail can be any identification detail relating to a telecommunications subscriber, i.e. as well as a telephone number or an e-mail address an SIP address or voice-over-IP address or any number which could be used for IN applications (or also applications in other nodes) for a connection setup etc, such as credit card numbers, auto numbers, zip codes.

1. Method for deciding whether to intercept a telecommunications connection wherein, for an identification detail relating to at least one subscriber of the telecommunications connection, a check is made as to whether this identification detail is included in at least one identification detail abbreviation relating to the subscriber to be monitored which is stored in a list, with interception of the telecommunications connection (6) being initiated if it is stored in the list.

2. Method according to claim 1, wherein the identification detail abbreviation is part of a identification detail relating to a mobile subscriber number.

3. Method in accordance with one of the previous claims, an identification detail abbreviation is part of an e-mail address of a telecommunications subscriber.

4. Method according to claim 3, wherein the identification detail abbreviation is a domain name or a part of a domain name in an e-mail address of a telecommunications subscriber.

5. Method according to claim 1, wherein an identification detail abbreviation is part of a telecommunications terminal identification (IMEI).

6. Method wherein the telecommunications connection is routed over a mobile radio network and/or fixed network and/or the Internet.

7. Method according to claim 1, wherein the checking is undertaken by equipment of a telecommunications network over which the telecommunications connection is routed or by equipment connected to it.

8. Method according to claim 1, wherein the interception is undertaken by official equipment.

9. Method according to claim 1, wherein identification details are checked when a connection is set up.

10. Method according to claim 1, wherein identification details of telecommunications subscribers are checked on transmission of data packets over a telecommunications connection.

11. A device for deciding whether to intercept telecommunications connections,
with a list of identification detail abbreviations relating to telecommunications subscribers to be intercepted stored in a memory,
with comparison equipment for comparing identification details transferred over a telecommunications connection relating to subscribers of the telecommunications connection with stored identification detail abbreviations,
with decision equipment to initiate the monitoring of a telecommunications connection with at least one telecommunications subscriber identified as to be monitored by an identification detail abbreviation.
